(19) United States
(12) Patent Application Publication
(10) Pub. No.: US 2025/0306793 A1
(43) Pub. Date: Oct. 2, 2025

(54) HYBRID DATA REPLICATION

(71) Applicant: Microsoft Technology Licensing, LLC, Redmond, WA (US)

(72) Inventor: Garret BUBAN, Snoqualmie, WA (US)

(21) Appl. No.: 18/622,000

(22) Filed: Mar. 29, 2024

(51) Int. Cl. G06F 3/06

(52) U.S. Cl. CPC G06F 3/065; G06F 3/0617; G06F 3/067

(57) ABSTRACT

System, methods, apparatuses, and computer program products are disclosed for hybrid data replication. Initially, data replication is achieved by storing at least one full copy of the data on one or more first nodes, and storing a second copy of the data as data fragments across a plurality of second nodes. Upon determining that a code generation condition is satisfied, one or more code fragments are generated based on the data. The full copies of the data stored on the first nodes may be deleted after storing the code fragments.

### BACKGROUND

Data replication improves data availability and resiliency through the creation and maintenance of redundant copies of data across different storage locations or systems. Data replication may be achieved through various techniques that are associated with tradeoffs. Full data replication, where full copies of data are stored at multiple storage locations or systems, provides high availability and reliability but requires significant storage overhead. Erasure coding involves breaking down data into data fragments, generating additional redundant code fragments based on the data fragments, and distributing the data fragments and code fragments across a plurality of storage locations or systems. Compared to full data replication, erasure coding provides efficient use of storage space while providing increased fault tolerance but requires additional computational overhead to generate the redundant code fragments and to reconstruct the original data from the fragments. The synchronicity of data replication operations may also include tradeoffs that affect the data availability and/or consistency.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

System, methods, apparatuses, and computer program products are disclosed for hybrid data replication. Initially, data replication is achieved by storing at least one full copy of the data on one or more first nodes, and storing a second copy of the data as data fragments across a plurality of data fragment nodes that are designated for storing data fragments. Upon determining that a code generation condition is satisfied, one or more code fragments are generated based on the data, and stored on one or more code fragment nodes that are designated for storing code fragments. The full copies of the data stored on the first nodes may be deleted after storing the redundant code fragments. After code fragments are generated, modifications to a data fragment are stored as a modified data fragment on the second node that stores the data fragment. Additionally, at least one additional copy of the modified data fragment is stored on another node. Upon determining that a code deletion condition is satisfied, at least one full copy of the current version of the data is created based on the data fragments and/or modified data fragments. The redundant code fragments may be deleted after storing the full copies of the current version of the data.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for hybrid data replication, in accordance with an embodiment.

FIGS. 2A, 2B, and 2C depict block diagrams of a state of an example system before, during, and after code fragment generation, respectively, in accordance with an embodiment.

FIG. 3 depicts a flowchart of a process for hybrid data replication, in accordance with an embodiment.

FIG. 4 depicts a flowchart of a process for generating and storing code fragments, in accordance with an embodiment.

FIG. 5 depicts a block diagram of a state of an example system after modifying data that is erasure coded, in accordance with an embodiment.

FIG. 6 depicts a flowchart of a process for modifying data that is erasure coded, in accordance with an embodiment.

FIGS. 7A and 7B depict a block diagram of a state of an example system during and after, code fragment deletion, respectively, in accordance with an embodiment.

FIG. 8 depicts a flowchart of a process for code fragment deletion, according to an example embodiment.

FIG. 9 depicts a flowchart of a process for processing an instruction that modifies data hybrid data replication, in accordance with an embodiment.

FIG. 10 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Data replication improves data availability and resiliency through the creation and maintenance of redundant copies of data across different storage locations or systems. Data replication may be achieved through various techniques that are associated with tradeoffs. For instance, full data replication, where data is copied to all nodes in the distributed system, ensures high availability and fault tolerance since every node contains a complete copy of the data. However, full data replication can be resource-intensive and inefficient as it requires significant storage space and network bandwidth for synchronization.

Erasure coding involves breaking data into data fragments, generating additional redundant code fragments based on the data fragments, and distributing the data fragments and code fragments across a plurality of storage nodes. By encoding the data fragments into a set of redundant code fragments, erasure coding enables the reconstruction of the original data from a subset of the data fragments and/or code fragments, thus providing fault tolerance even if some fragments are lost and/or corrupted. Compared to full data replication, erasure coding provides efficient use of storage space while providing increased fault tolerance. However, erasure coding requires additional computational resources to generate the redundant code fragments and to reconstruct the original data from the redundant code fragments. Additionally, encoding and/or decoding the data introduces additional latency in comparison to other data replication strategies.

The synchronicity of data replication operations may also include tradeoffs that affect the data availability and/or consistency. For instance, with synchronous replication, data is replicated to multiple replica nodes simultaneously, and a data update is considered committed after all replica nodes have acknowledged receipt of the data update. While synchronous replication ensures consistency because all replica nodes are guaranteed to have the same data at all times, synchronous replication may introduce latency overhead associated with waiting for acknowledgments from all replica nodes. In contrast, asynchronous replication allows updates to be acknowledged before all replica nodes are updated. While this strategy reduces latency, it can lead to inconsistencies between data stored on the replica nodes as they may update their copy of the data at different points in time. Additionally, in the event a primary node fails before updates are propagated to all replica nodes, data loss may also occur.

Quorum replication provides a middle ground between synchronous and asynchronous replication. It operates on the principle of quorums, which are subsets of nodes that must agree on a certain operation for it to be considered successful. In quorum replication, a data update operation is committed when a sufficient number of nodes, known as the quorum, acknowledge the operation. Compared to asynchronous replication, quorum replication provides stronger data consistency and fault tolerance because data updates are committed if they are acknowledged by a quorum of the replica nodes. In contrast to synchronous replication, quorum replication introduces less latency due to the fact that acknowledgements are not required from all of the replica nodes.

Embodiments described herein are directed to a hybrid data replication approach that combines aspects of full data replication and erasure coding. In embodiments, data is initially stored and managed based on a modified full data replication approach. For instance, a first full copy of data is stored on a first node while a second copy of the data is stored as data fragments across a plurality of second nodes. In embodiments, the plurality of second nodes is designated as data fragment nodes that will store the data fragments after erasure coding, thus obviating the need to move the data fragments during erasure coding. In embodiments, additional full copies of the data are stored on additional nodes to increase fault tolerance, data availability, performance, and/or the like. As the replicated data is modified, data updates are provided to the first node storing the full copy of the data and to the second nodes storing data fragments that are modified.

In embodiments, a modified quorum-based replication approach provides data consistency across the replica nodes during data updates. Because the second copy of the data is stored across a plurality of second nodes as data fragments, not all second nodes will be required to process the data updates. In embodiments, data updates are processed by providing an updated data fragment to the nodes required to process the updated data fragment, and a NOP operation to the remaining replica nodes. In this approach, a data update is considered to be successful when, for example, acknowledgements are received from a first quorum (e.g., majority) of the nodes required to process the updated data fragment, and from a second quorum (e.g., majority) of all the replica nodes (including replica nodes provided with a NOP operation).

In embodiments, the data is stored and managed based on the modified full data replication approach until satisfaction of a predetermined code generation condition that is based on, for example, but not limited to, a modification frequency associated with the data, a proportion of the data that has been modified during a predetermined time period, a computational cost associated with erasure coding, an amount of time elapsed since a modification of the data, and/or the like. When the predetermined code generation condition is satisfied, data replication transitions from the modified full data replication approach to a modified erasure coding approach. For example, when the benefits of erasure coding outweigh the costs associated with erasure coding, the data is erasure coded by generating redundant code fragments based on the first copy of the data stored at the first node and/or the data fragments constituting the second copy of the data stored across the second nodes, and storing the generated redundant code fragments across a plurality of nodes. In embodiments, the redundant code fragments are stored on nodes other than the second nodes storing the data fragments. Once the redundant code fragments are stored across the plurality of nodes, in embodiments, the first full copy of the data is deleted from the first node in order to free up storage resources associated therewith.

In the modified erasure coding approach, modifications to the data fragments are, in embodiments, maintained separately from the erasure coded data fragments. For instance, when a data fragment is modified, a modified data fragment is generated and replicatively stored as a first copy at the same second node that stores the data fragment that was modified and as additional copies at additional nodes. In embodiments, subsequent modifications to the data fragment are executed based on modified data fragment and the result overwrites the modified data fragment. In embodiments, the particular data fragment that was modified is maintained as part of the erasure coded data fragments in order to, for example, permit reconstruction of (other) fragments. In embodiments, the second copies of the modified data fragment are stored on the replica nodes storing the redundant code fragments, and/or on any other nodes. In embodiments, read requests for the data are processed based on the data fragments that were erasure coded if the data fragments have not been modified since erasure coding, or based on the modified data fragments if the data fragments have been modified since erasure coding.

In embodiments, the data is stored and managed based on the modified erasure coding approach until satisfaction of a predetermined code deletion condition that is based on, for example, but not limited to, a modification frequency associated the erasure coded data fragments, a proportion of the erasure coded data fragments that have been modified since erasure coding, a computational cost associated with erasure coding, and/or the like. For example, when a significant portion of the erasure coded data fragments have been modified, the costs of maintaining the erasure coded data fragments and the redundant code fragments may outweigh the benefits associated with erasure coding. When the predetermined code deletion condition is satisfied, in embodiments, the data is transitioned back to the modified full data replication approach discussed above by generating a full copy of the current version of the data and storing it at one or more replica nodes. In embodiments, the full copy of the current version of the data is be stored at the replica nodes storing the redundant code fragments. Upon storing the full copy of the current version of the data, in embodiments, the redundant code fragments and the erasure coded data fragments that were modified are deleted from the replica nodes.

In embodiments, hybrid data replication is achieved by transitioning between the modified full data replication approach and the modified erasure coding approach, and vice versa, based on the satisfaction of the predetermined code generation condition and the predetermined code deletion condition, respectively. Efficiencies are realized by, for example, employing aspects of full data replication when the costs associated with erasure coding outweigh the benefits of erasure coding, and employing aspects of erasure coding when the benefits of erasure coding outweigh the costs associated with erasure coding. Further efficiencies are realized by, for example, storing a copy of the data as data fragments across replica nodes that will store the data fragments after erasure coding. This approach obviates the need to move the data fragments during the erasure coding process. In embodiments, by storing the data fragments in known storage locations that do not change after erasure coding, performance gains are realized because read requests can be processed by requesting the data fragments directly from the known locations.

These and further embodiments are disclosed herein that enable the functionality described above and additional functionality. Such embodiments are described in further detail as follows.

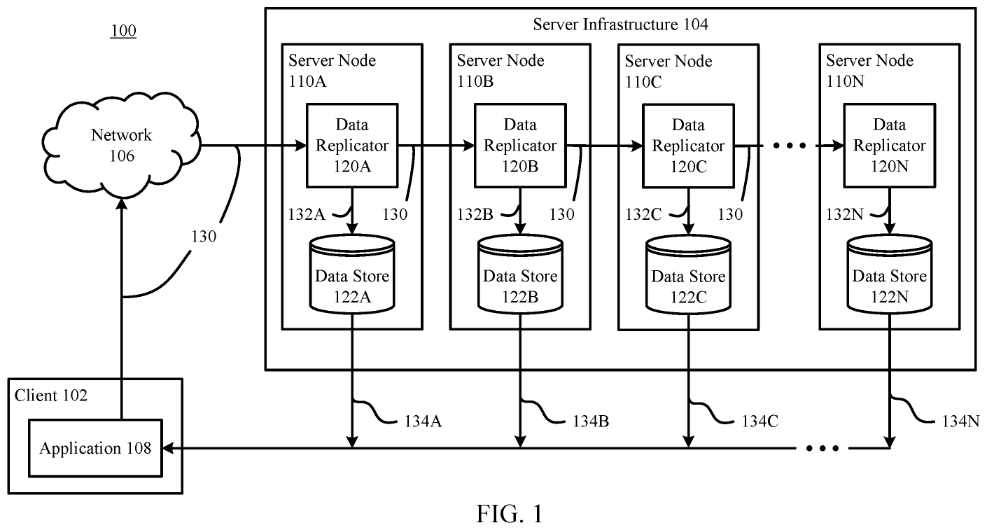

For instance, FIG. 1 shows a block diagram of an example system 100 for hybrid data replication, in accordance with an embodiment. As shown in FIG. 1, system 100 includes a client 102 and a server infrastructure 104 communicatively coupled via a network 106. Client 102 further includes an application 108, and server infrastructure 104 further includes two or more server nodes 110A-110N. Server node(s) 110A-110N include data replicators 120A-120N and data stores 122A-122N, respectively. System 100 is described in further detail as follows.

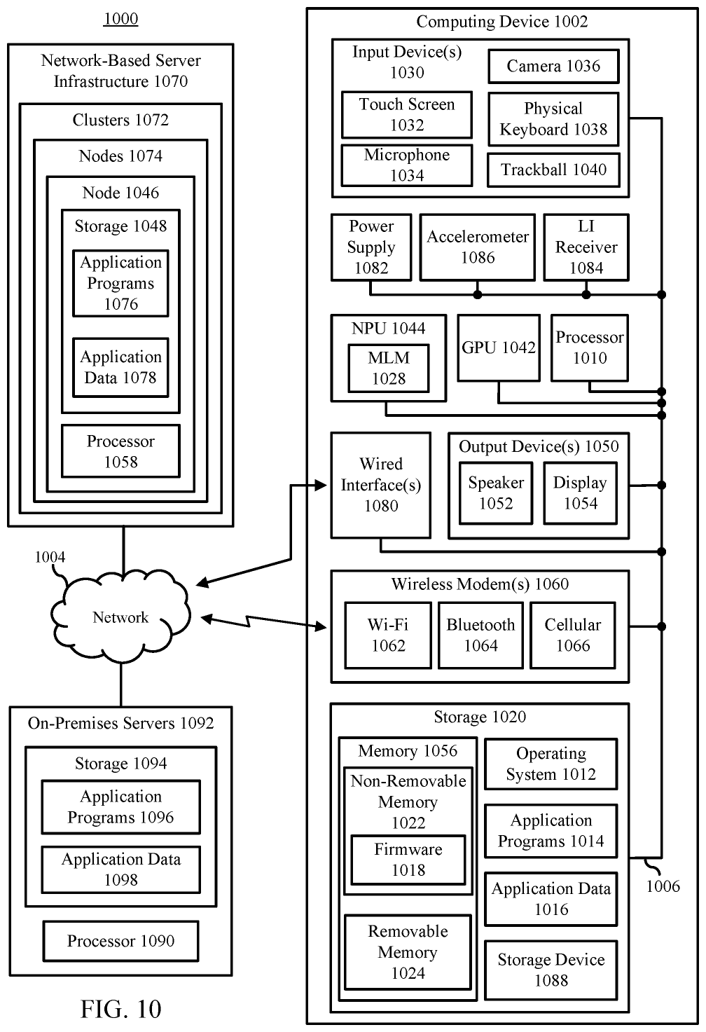

Client 102 comprises any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. As shown in FIG. 1, client 102 includes an application 108. Various example implementations of client 102 are described below in reference to FIG. 10 (e.g., computing device 1002, nodes 1074, on-premises servers 1092, and/or components thereof).

Server infrastructure 104 comprises a network-accessible server set (e.g., cloud-based environment or platform). In an embodiment, the underlying resources of server infrastructure 104 are co-located (e.g., housed in one or more nearby buildings with associated components such as backup power supplies, redundant data communications, environmental controls, etc.) to form a datacenter, are distributed across different regions, and/or are arranged in other manners. As shown in FIG. 1, server infrastructure 104 further includes server node(s) 110A-110N. Various example implementations of server infrastructure 104 are described below in reference to FIG. 10 (e.g., network-based server infrastructure 1070, and/or components thereof).

Network 106 comprises one or more networks such as local area networks (LANs), wide area networks (WANs), enterprise networks, the Internet, etc., and may include one or more wired and/or wireless portions. Various example implementations of network 106 are described below in reference to FIG. 10 (e.g., network 1004, and/or components thereof).

Application 108 comprises any type of application, such as, but not limited to, mobile applications, desktop applications, a web browser, server applications, scripts, and/or the like. In embodiments, application(s) 110 includes, but are not limited to, work applications (e.g., word processer, spreadsheets, presentation, computer assisted drafting (CAD), development environments, bookkeeping, productivity, calendar, etc.), personal application(s) (e.g., television, video game, entertainment, etc.), communications applications (e.g., videoconferencing, instant messaging, chat, audioconferencing, e-mail, etc.), internet applications (e.g., web browser, etc.), and/or OS processes (e.g., system updater, automatic backup service, etc.). In embodiments, application 108 communicates with server infrastructure 104, and/or components thereof, to read, write, and/or otherwise modify data replicatively stored in data store(s) 122A-122N. Various example implementations of application 108 are described below in reference to FIG. 10 (e.g., application programs 1014, application programs 1076, application programs 1096, and/or components thereof).

Server node(s) 110A-110N comprise one or more physical and/or virtual servers capable of replicatively storing data. In embodiments, server node(s) 110A-110N are located in separate locations and/or separate physical servers. As shown in FIG. 1, server node(s) 110A-110N include data replicator(s) 120A-120N, respectively, and data store(s) 122A-122N, respectively. In embodiments, server node(s) 110A-110N are configured to receive data 130 for storage on data store(s) 122A-122N. In embodiments, server node(s) 110A-110N are configured to process read requests (not depicted) by returning one or more responses 134A-134N. Various example implementations of server node(s) 110A-110N are described below in reference to FIG. 10 (e.g., nodes 1074, node 1046, and/or components thereof).

While FIG. 1 depicts a particular number of server nodes, in embodiments, server infrastructure 104 may include fewer or additional server nodes based on the level of fault tolerance required for the replicated data. For example, in (6, 3) erasure coding, data is replicated across nine server nodes, with the data fragments stored across six of the nine server nodes and the redundant code fragments stored across the other three server nodes. Such a scheme can sustain up to three failures (e.g., data loss, data corruption, etc.) to three of server nodes without suffering data loss.

Data replicator(s) 120A-120N are configured to replicatively store data across server node(s) 110A-110N. In embodiments, data replicator(s) 120A-120N receive data 130 for storage across server node(s) 110A-110N, and propagate data 130 to one or more other data replicator(s) 120A-120N located on server node(s) 100A-100N. In embodiments, data replicator(s) 120A-120N receive data 130, and/or portions thereof, from one or more other data replicator(s) 120A-120N located on server node(s) 100A-100N, and store data 130 and/or portions thereof, in data store(s) 122A-122N via one or more write operations 132A-132N. In embodiments, data replicator(s) 120A-120N are configured to handle various data replication tasks, such as, but not limited to, data synchronization, conflict resolution, error handling, data compression, data encryption, data decryption, data deduplication, and/or the like. In embodiments, data replicator(s) 120A-120N are implemented in software, firmware, hardware, and/or any combination thereof.

Data store(s) 122A-122N comprise any type of storage data in a manner to support data replication across server node(s) 110A-110N. Various example implementations of data store(s) 122A-122N are described below in reference to FIG. 10 (e.g., storage 1020, memory 1056, removable memory 1024, storage device 1088, storage 1048, storage 1094, and/or components thereof).

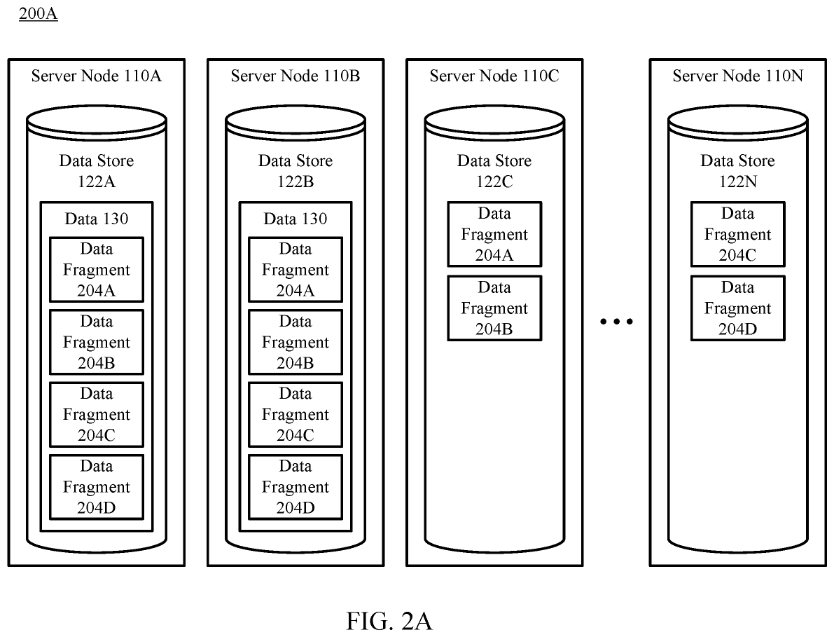

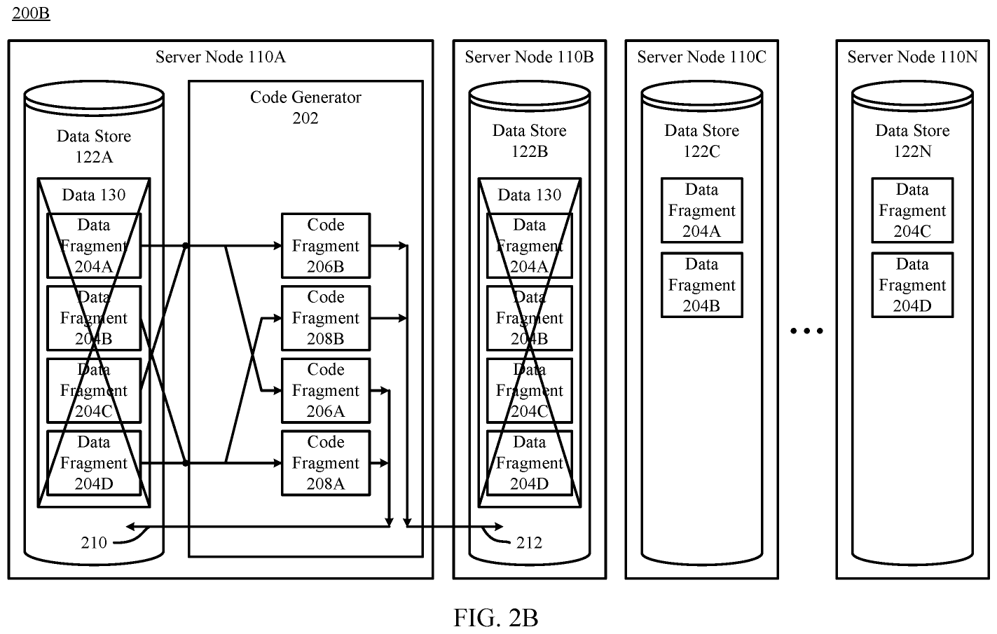

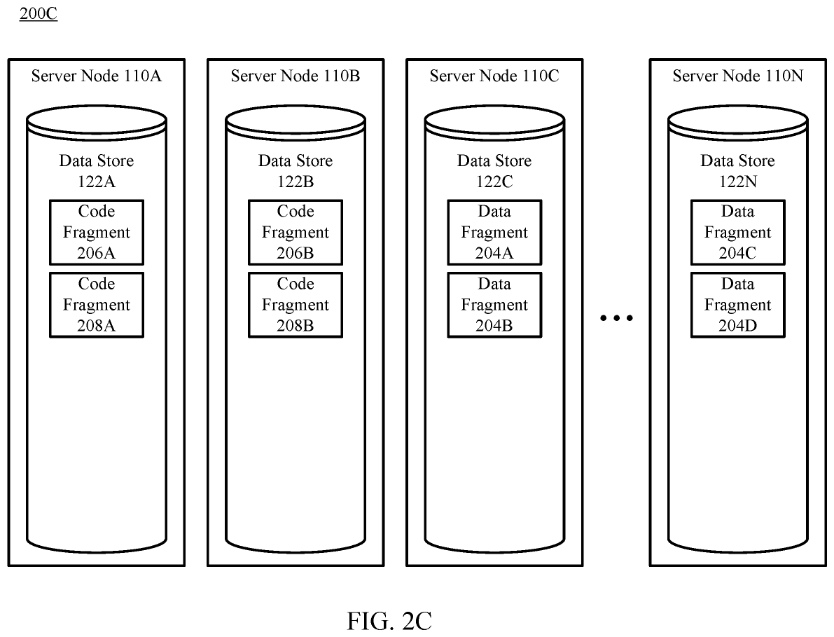

Embodiments described herein may operate in various ways to perform erasure coding. For instance, FIGS. 2A, 2B, and 2C depict block diagrams of example systems 200A, 200B, and 200C, respectively, that represent a state before, during, and after code fragment generation, respectively, in accordance with an embodiment. As shown in FIGS. 2A, 2B, and 2C, systems 200A, 200B, and 200C include server node(s) 110A-110N that, respectively, include data store(s) 122A-122N. Furthermore, as shown in FIG. 2B, server node 110A further includes a code generator 202. While FIG. 2B only depicts a single code generator 202 on server node 110A, in embodiments, additional code generators 202 reside on one or more of server node(s) 110A-110N. As shown in FIG. 2A, prior to code fragment generation, data store(s) 122A-122B further includes data 130, which comprises the data of one or more data fragments 204A-204D, data store 122C further includes one or more data fragments 204A-204B, and data store 122N further includes one or more data fragments 204C-D. While FIG. 2A depicts data 130 as including the data of four data fragments, in embodiments, data 130 may contain data of fewer or additional data fragments. As shown in FIG. 2B, during code fragment generation, code generator 202 generates one or more code fragments 206A-206B based on data fragment(s) 204A and 204C, generates one or more code fragments 208A-208B based on data fragment(s) 204B and 204D, stores code fragment(s) 206A and 208A in data store 122A, and stores code fragment(s) 206B and 208B in data store 122B. FIG. 2B also shows the deletion of data 130 from data store(s) 122A-122B. As shown in FIG. 2C, after code fragment generation, data store 122A includes code fragment(s) 206A and 208A, data store 122B includes code fragment(s) 206B and 208B, data store 122C includes data fragment(s) 204A-204B, and data store 122N includes data fragment(s) 204C-D. Systems 200A, 200B, and 200C will be described in further detail as follows.

Data fragment(s) 204A-204D comprise portions of a larger dataset. In embodiments, data fragment(s) 204A-204D are generated by dividing or segmenting a larger piece of data and storing the generated data fragments in data store(s) 122A-122N. In embodiments, data fragment(s) 204A-204D are provided to server node(s) 110A as smaller pieces of data that are used to generate data fragment(s) 204A-204D. For example, data is accumulated and/or appended until the accumulated data nears a data fragment size, at which point, a new data fragment is created to store any additional data. In embodiments, data fragment(s) 204A-204D comprise data of uniform size and/or comprise data that is padded until data fragment(s) 204A-204D are of uniform size.

Code generator 202 is configured to generate redundant code fragments (e.g., code fragment(s) 206A-206B and/or 208A-208B) based on one or more data fragments (e.g., data fragment(s) 204A-204D) to protect data against loss or corruption. In embodiments, code generator 202 generates code fragment(s) 206A-206B and/or 208A-208B by performing one or more operations (e.g., arithmetic operation, bitwise operations) on a plurality of data fragments. For example, as shown in FIG. 2B, code fragment(s) 206A-206B are generated by performing one or more operations on data fragment(s) 204A and 204C, and code fragment(s) 208A-208B are generated by performing one or more operations on data fragment(s) 204B and 204D. In embodiments, code generator 202 generates code fragment(s) 206A-206B and/or 208A-208B using various techniques, such as, but not limited to, Reed-Solomon encoding, systematic encoding, and/or the like. For instance, in Reed-Solomon encoding, the original data fragments are represented as coefficients of a polynomial, and redundant code fragments are generated by evaluating the polynomial at different points. In embodiments, code generator 202 generates, based on data fragment(s) 204A and 204C, distinct code fragment(s) 206A and 206B by evaluating a polynomial at different points. Similarly, in embodiments, code generator 202 generates, based on data fragment(s) 204B and 204D, distinct code fragment(s) 208A and 208B by evaluating the polynomial at different points. In order to increase fault tolerance, code fragment(s) 206A and 208A are, in embodiments, stored separately from code fragment(s) 206B and 208B on different server node(s) 110A-110N. For similar reasons, data fragment(s) 204A-204D are, in embodiments, stored separately from code fragment(s) 206A-206B and/or 208A-208B on different server node(s) 110A-110N.

Code fragment(s) 206A-206B and/or 208A-208B comprise redundant code fragments generated by code generator 202 that permit some level of data loss tolerance by enabling reconstruction of one or more of the data fragments used to generate the code fragment. For instance, code fragment(s) 206A and/or 206B can be used to reconstruct one or more of data fragment(s) 204A and/or 204C, and code fragment(s) 208A and/or 208B can be used to reconstruct one or more of data fragment(s) 204B and/or 204D.

While FIG. 2B depicts the generation of a particular number of code fragments, in embodiments, code generator 202 may generate fewer or additional code fragments based on the level of fault tolerance required for the replicated data. For example, in (6, 3) erasure coding, data is replicated across nine server nodes, with the data fragments stored across six of the nine server nodes and the redundant code fragments stored across the other three server nodes. In such a scheme, code generator 202 would generate three distinct redundant code fragments from three distinct data fragments.

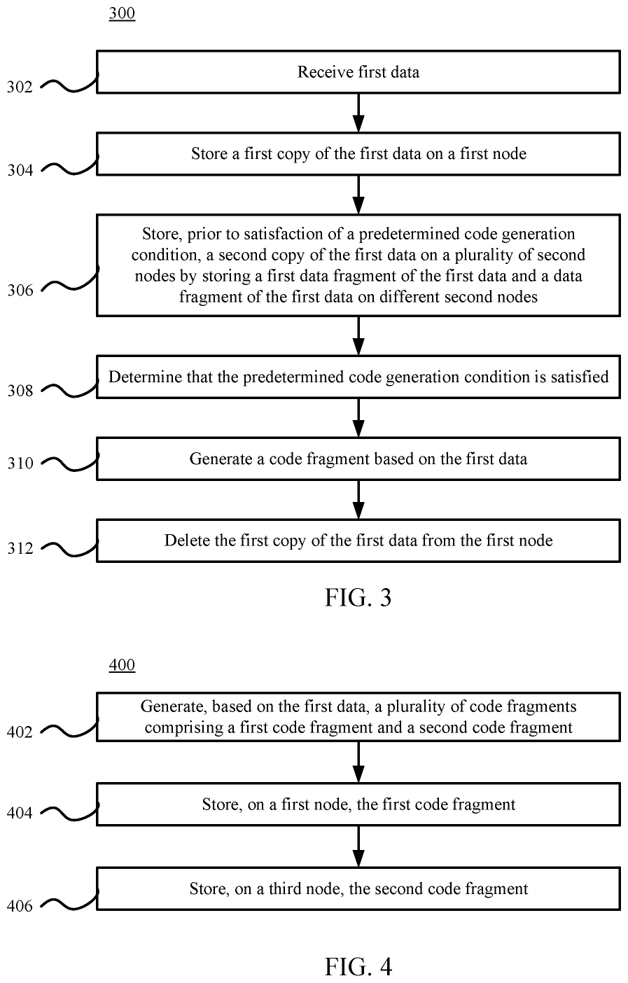

Embodiments described herein may operate in various ways to perform hybrid data replication. For instance, FIG. 3 depicts a flowchart 300 of a process for hybrid data replication, in accordance with an embodiment. Server infrastructure 104, server node(s) 110A-110N, data replicator(s) 120A-120N, data store(s) 122A-122N, and/or code generator 202 may operate according to flowchart 300, for example. Note that not all steps of flowchart 300 may need to be performed in all embodiments, and in some embodiments, the steps of flowchart 300 may be performed in different orders than shown. Flowchart 300 is described as follows with respect to FIGS. 1 and/or 2A-2C for illustrative purposes.

Flowchart 300 starts at step 302. In step 302, first data is received. For example, server node 110A receives data 130 from application 108 of client 102 via network 106. In embodiments, data 130 comprises the data of data fragment(s) 204A-204D.

In step 304, a first copy of the first data is stored on a first node. For example, server node 110A stores a first copy of data 130 on server node(s) 110A-110B by performing write operation(s) 132A-132B to store the data of data fragment(s) 204A-204D on data store(s) 122A-122B.

In step 306, prior to satisfaction of a predetermined code generation condition, a second copy of the first data is stored on a plurality of second nodes by storing a first data fragment of the first data and a second data fragment of the first data on different second nodes. For example, a second copy of data 130 is stored on server nodes 110C and 110N by performing a write operation 132C to store data fragment(s) 204A and 204B on server node 110C and by performing a write operation 132N to store data fragment(s) 204C and 204D on server node 110N. In embodiments, data replicator 120A of server node 110A replicates data 130, and/or portions thereof, to server node(s) 110C and/or 110N for storage thereon.

In step 308, the predetermined code generation condition is determined to be satisfied. For instance, server node(s) 110A-110N monitors modifications made to data fragment(s) 204A-204D to determine whether the predetermined code generation condition is satisfied. In embodiments, the predetermined code generation condition is based on one or more factors, such as, but not limited to, a modification frequency associated with data 130, a proportion of data 130 that has been modified during a predetermined time period, a computational cost associated with generation of code fragment(s) 206A-206B and/or 208A-208B, an amount of time elapsed since a last modification of data 130, and/or any combination thereof. In embodiments, the predetermined code generation condition is satisfied based on one or more factors satisfying a predetermined relationship with one or more predetermined thresholds, based on a composite score or metric, that is generated based on one or more factors, satisfying a score or metric threshold, and/or any combination thereof.

In step 310, a code fragment is generated based on the first data. For example, code generator generates code fragment(s) 206A-206B by performing one or more operations on data fragment(s) 204A and 204C, and generates code fragment(s) 208A-208B by performing one or more operations on data fragment(s) 204B and 204D. In embodiments, code generator 202 generates code fragment(s) 206A-206B and/or 208A-208B using various techniques, such as, but not limited to, Reed-Solomon encoding, systematic encoding, and/or the like. While FIG. 2B depicts code generation based on the copy of data 130 stored on server node 110A, in embodiments, code fragment(s) 206A-206B and/or 208A-208B can be generated from any copy of data fragment(s) 204A-204D stored on server(s) 110A-110N and/or at any other location.

In step 312, the first copy of the first data is deleted from the first node. For example, as depicted in FIG. 2B, data 130 is deleted from server node(s) 110A and/or 110B.

Embodiments described herein may operate in various ways to generate and store code fragments. For instance, FIG. 4 depicts a flowchart 400 of a process for generating and storing code fragments, in accordance with an embodiment. Server infrastructure 104, server node(s) 110A-110N, data replicator(s) 120A-120N, data store(s) 122A-122N, and/or code generator 202 may operate according to flowchart 400, for example. Note that not all steps of flowchart 400 may need to be performed in all embodiments, and in some embodiments, the steps of flowchart 400 may be performed in different orders than shown. Flowchart 400 is described as follows with respect to FIGS. 1 and/or 2A-2C for illustrative purposes.

Flowchart 400 starts at step 402. In step 402, a plurality of code fragments are generated based on the first data, the plurality of code fragments comprising a first code fragment and a second code fragment. For example, code generator generates code fragment(s) 206A-206B by performing one or more operations on data fragment(s) 204A and 204C, and generates code fragment(s) 208A-208B by performing one or more operations on data fragment(s) 204B and 204D. In embodiments, code generator 202 generates code fragment(s) 206A-206B and/or 208A-208B using various techniques, such as, but not limited to, Reed-Solomon encoding, systematic encoding, and/or the like.

In step 404, the first code fragment is stored on a first node. For example, code fragment(s) 206A and 208A are stored on server node 110A. In embodiments, code fragment(s) 206A and 208A are provided as code fragments 210 to data store 122A.

In step 406, the second code fragment is stored on a third node. For example, code fragment(s) 206B and 208B are stored on server node 110B. In embodiments, code fragment(s) 206B and 208B are provided as code fragments 212 to data store 122B via data replicator(s) 120A and/or 120B.

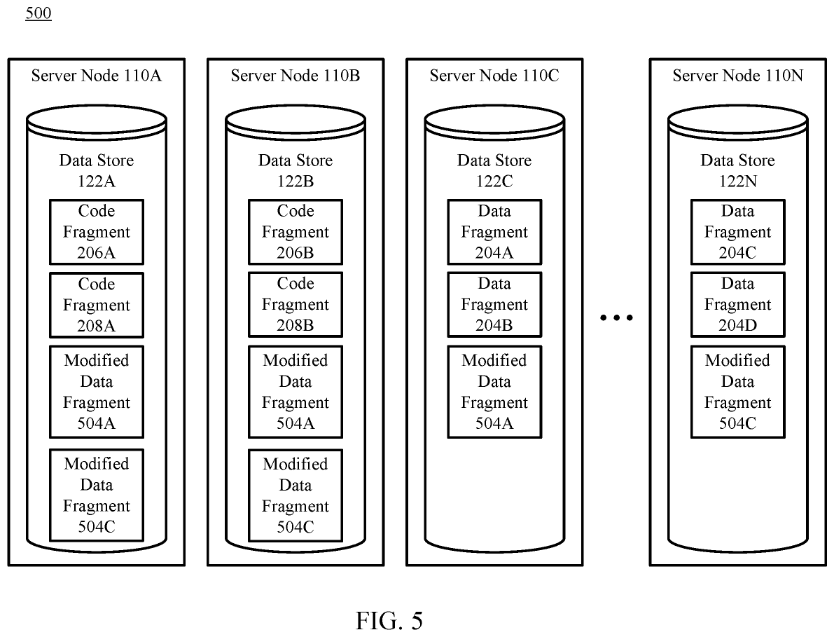

Embodiments described herein may operate in various ways to modify data that is erasure coded. For instance, FIG. 5 depicts a block diagram of an example system 500 that represents a state after modifying data that is erasure coded, in accordance with an embodiment. As shown in FIG. 5, data store 122A includes code fragment(s) 206A and 208A and modified data fragment(s) 504A and 504C, data store 122B includes code fragment(s) 206B and 208B and modified data fragment(s) 504A and 504C, data store 122C includes data fragment(s) 204A-204B and modified data fragment 504A, and data store 122N includes data fragment(s) 204C-204D and modified data fragment 504C. System 500 is described in further detail as follows.

Modified data fragment(s) 504A and/or 504C correspond to modified versions of data fragment(s) 204A and 204C, respectively. For example, after erasure coding, when a instruction modifying data fragment 204A is detected, the instruction is executed based on data fragment 204A, and the result of executing the instruction is stored as a modified data fragment 504A. In embodiments, data fragment 204A remains unmodified in order to preserve fault tolerance provided by the data fragment 204A in reconstructing other fragments (e.g., data fragment 204C, code fragment(s) 206A-206B, etc.). In embodiments, subsequent instructions that modify data fragment 204A are executed based on modified data fragment 504A and the result of executing the subsequent instructions overwrite modified data fragment 504A.

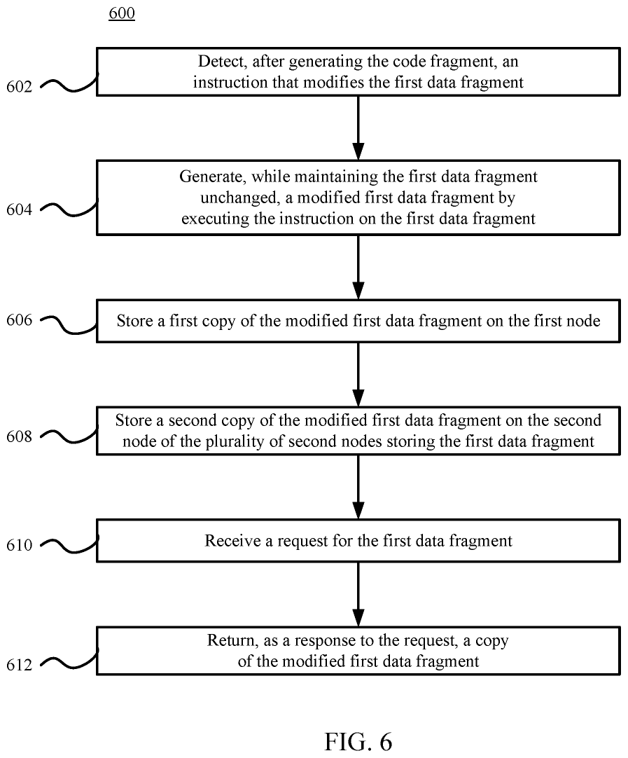

Embodiments described herein may operate in various ways to modify erasure coded data. FIG. 6 depicts a flowchart of a process for modifying erasure coded data, in accordance with an embodiment. Server infrastructure 104, server node(s) 110A-110N, data replicator(s) 120A-120N, data store(s) 122A-122N, and/or code generator 202 may operate according to flowchart 600, for example. Note that not all steps of flowchart 600 may need to be performed in all embodiments, and in some embodiments, the steps of flowchart 600 may be performed in different orders than shown. Flowchart 600 is described as follows with respect to FIGS. 1, 2A-2C, and/or FIG. 5 for illustrative purposes.

Flowchart 600 starts at step 602. In step 602, after generating the code fragment, an instruction that modifies the first data fragment is detected. For example, server node(s) 110A-110N determine that an instruction (not depicted) modifies data fragment(s) 204A and/or 204C.

In step 604, while maintaining the first data fragment unchanged, a modified first data fragment is generated by executing the instruction on the first data fragment. For example, server node(s) 110A-110N execute the instruction that modify data fragment(s) 204A and/or 204C by generating modified data fragment(s) 504A and/or 504C, respectively.

In step 606, a first copy of the modified first data fragment is stored on the first node. For example, server node(s) 110A-110N store a first copy of modified data fragment(s) 504A and/or 504C on one or more of server node(s) 110A-110B.

In step 608, a second copy of the modified first data fragment is stored on the second node of the plurality of second nodes storing the first data fragment. For example, server node(s) 110A-110N store a second copy of modified data fragment 504A on server node 110C that stores data fragment 204A, and/or a second copy of modified data fragment 504C on server node 110N that stores data fragment 204C.

In step 610, a request for the first data fragment is received. For example, server node(s) 110A-110N receive a request (not depicted) for data fragment(s) 204A and/or 204C.

In step 612, the modified first data fragment is returned as a response to the request. For example, server node(s) 110A-110N return, in response to the request, modified data fragment(s) 504A and/or 504C as response(s) 134A-134N.

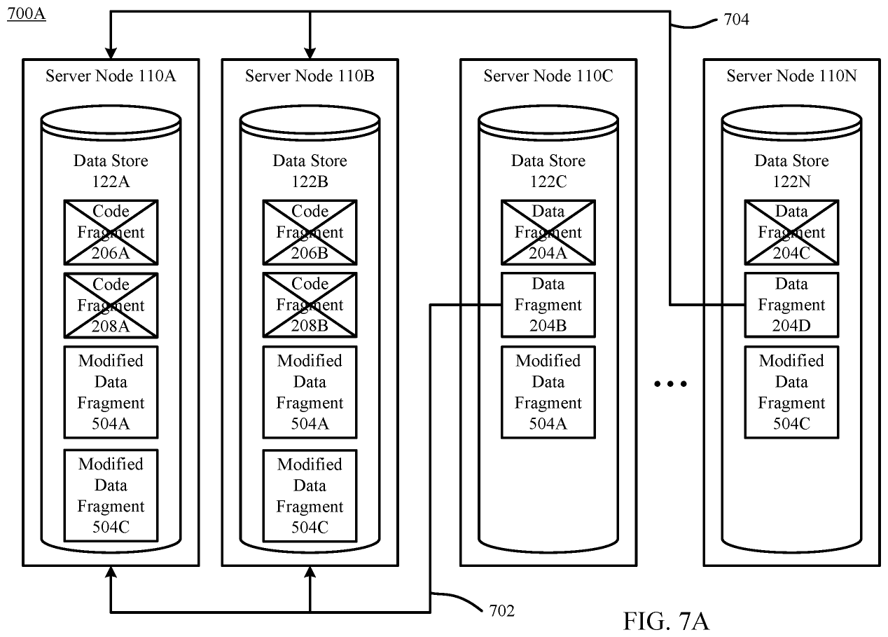

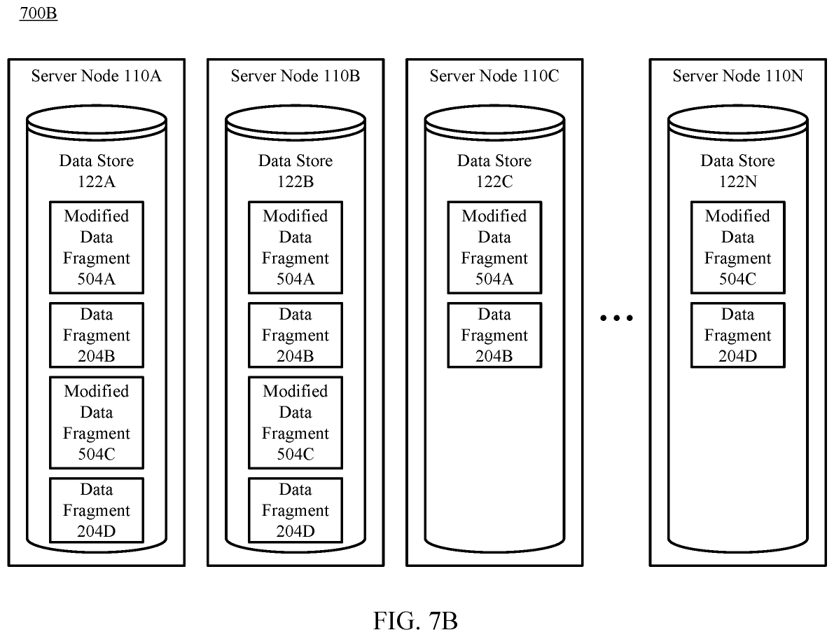

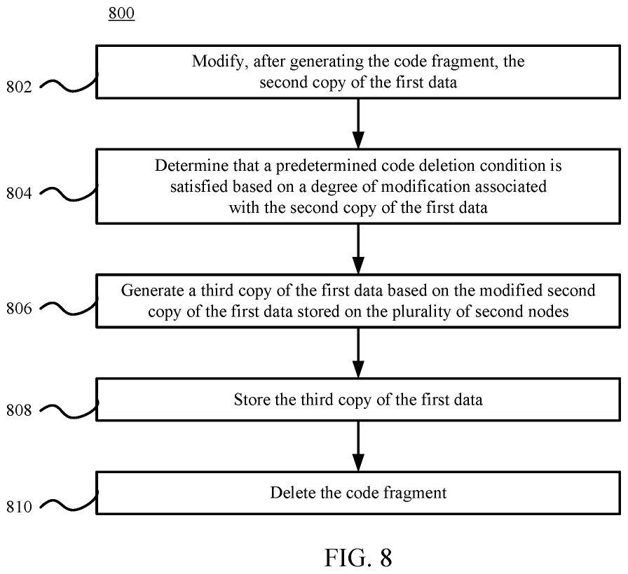

Embodiments described herein may operate in various ways to perform code fragment deletion. FIGS. 7A and 7B depict block diagrams of example systems 700A and 700B, respectively, that represent a state during and after code fragment deletion, respectively, in accordance with an embodiment. As shown in FIG. 7A, during code fragment deletion, data fragment(s) 204B and 204D are copied to data store(s) 122A-122B, data fragment(s) 204A and 204C are, respectively, deleted from data store(s) 122C and 122N, code fragment(s) 206A and 208A are deleted from data store 122A, and code fragment(s) 206B and 208B are deleted from data store 122B. As shown in FIG. 7B, after code fragment deletion, data store(s) 122A-122B include modified data fragment 504A, data fragment 204B, modified data fragment 504C and data fragment 204D. Additionally, data store 122C includes modified data fragment 504A and data fragment 204B, and data store 122N includes modified data fragment 504C and data fragment 204D. Systems 700A and 700B are described in further detail below in conjunction with FIG. 8.

Embodiments described herein may operate in various ways to perform code fragment deletion. FIG. 8 depicts a flowchart of a process for code fragment deletion. Server infrastructure 104, server node(s) 110A-110N, data replicator(s) 120A-120N, data store(s) 122A-122N, and/or code generator 202 may operate according to flowchart 800, for example. Note that not all steps of flowchart 800 may need to be performed in all embodiments, and in some embodiments, the steps of flowchart 800 may be performed in different orders than shown. Flowchart 800 is described as follows with respect to FIGS. 1, 2A-2C, 5, and/or FIG. 7 for illustrative purposes.

Flowchart 800 starts at step 802. In step 802, after generating the code fragment, the second copy of the first data is modified. For example, server node(s) 110A-110N receive one or more requests to modify data fragment(s) 204A-204D stored on server node(s) 110C and/or 110N.

In step 804, a predetermined code deletion condition is determined to be satisfied based on a degree of modification associated with the second copy of the first data. For instance, server node(s) 110A-110N monitor modifications made to data fragment(s) 204A-204D to determine whether the predetermined code deletion condition is satisfied. In embodiments, the predetermined code deletion condition is based on one or more factors, such as, but not limited to, a modification frequency associated data fragment(s) 204A-204D after erasure coding, a proportion of data fragment(s) 204A-204D that have been modified since erasure coding, a computational cost associated with generating code fragment(s) 206A-206B and/or 208A-208B, and/or any combination thereof. For example, when a significant portion of the erasure coded data fragments have been modified, the costs of maintaining the erasure coded data fragments and the redundant code fragments may outweigh the benefits associated with erasure coding. In embodiments, the predetermined code deletion condition is satisfied based on one or more factors satisfying a predetermined relationship with one or more predetermined thresholds, based on a composite score or metric, that is generated based on one or more factors, satisfying a score or metric threshold, and/or any combination thereof.

In step 806, a third copy of the first data is generated based on the modified second copy of the first data stored on the plurality of second nodes. For example, as depicted in FIG. 7A, server node(s) 110A-110N generate a third copy of the first data by replicating unmodified data fragment(s) 204B and/or 204D to server node(s) 110A-110B via one or more communications 702 and/or 704, respectively.

In step 808, the third copy of the first data is stored. For example, as depicted in FIG. 7B, a copy of the data comprising unmodified data fragment(s) 204B and/or 204D and modified data fragment(s) 504A and/or 504C are stored on server node(s) 110A-B.

In step 810, the code fragment is deleted. For example, as depicted in FIG. 7A, server node(s) 110A-110N delete code fragment(s) 206A and 208A from server node 110A, and code fragment(s) 206B and 208B from server node 110B.

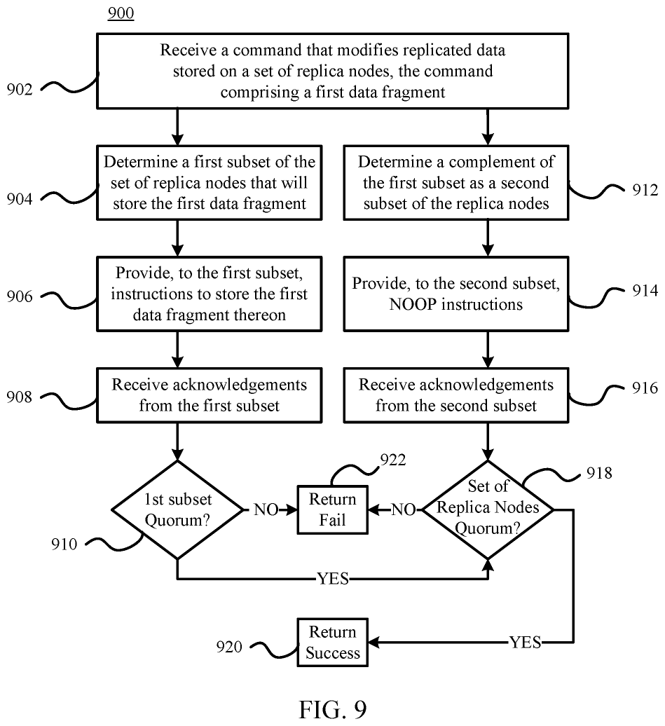

Embodiments described herein may operate in various ways to process an instruction that modifies hybrid replicated data. FIG. 9 depicts a flowchart of a process for processing an instruction that modifies hybrid replication data. Server infrastructure 104, server node(s) 110A-110N, data replicator(s) 120A-120N, data store(s) 122A-122N, and/or code generator 202 may operate according to flowchart 900, for example. Note that not all steps of flowchart 900 may need to be performed in all embodiments, and in some embodiments, the steps of flowchart 900 may be performed in different orders than shown. Flowchart 900 is described as follows with respect to FIGS. 1, 2A-2C, 5, and/or FIG. 7 for illustrative purposes.

Flowchart 900 starts at step 902. In step 902, an instruction that modifies replicated data stored on a set of replica nodes is received, the instruction comprising a first data fragment. For example, server node(s) 110A-110N receive an instruction (not depicted) that modified replicated data (e.g., data fragment(s) 204A-204D) and that includes a new data fragment (not depicted) to overwrite an existing data fragment (e.g., data fragment 204A).

In step 904, a first subset of the set of replica nodes that will store the first data fragment is determined. For example, server node(s) 110A-110N determine that the new data fragment should overwrite the existing data fragment (e.g., data fragment 204A) stored on server node(s) 110A-110C.

In step 906, instructions are provided to the first subset to store the first data fragment thereon. For example, server node(s) 110A-110N provide instructions to server node(s) 110A-110C to overwrite an existing data fragment (e.g., data fragment 204A) with the new data fragment.

In step 908, acknowledgements are received from the first subset. For example, server node(s) 110A-110N receive acknowledgements (not depicted) from server node(s) 110A-110C.

In step 910, it is determined whether acknowledgements have been received from a quorum of the first subset. For example, server node(s) 110A-110N determine whether acknowledgements have been received from a quorum (e.g., majority) of server node(s) 110A-110N. In embodiments, if it is determined that acknowledgements have been received from a quorum of the first subset, flowchart 900 proceeds to step 918, otherwise flowchart 900 proceeds to step 922. In embodiments, flowchart 900 proceeds to step 922 after the expiration of an acknowledgement timeout in order to provide sufficient time for acknowledgements to be received.

In step 912, a second subset of the set of replica nodes is determined as a complement of the first subset. For example, server node(s) 110A-110N determine a second subset of server node(s) 110A-110N that do not include the first subset (e.g., server node(s) 110A-110N) that store the existing data fragment (e.g., data fragment 204A).

In step 914, NOP instructions are provided to the second subset. For example, server node(s) 110A-110N provide NOP instructions to the second subset of server nodes (e.g., server node 110N).

In step 916, acknowledgements are received from the second subset. For example, server node(s) 110A-110N receive acknowledgements from the second subset of server nodes (e.g., server node 110N).

In step 918, it is determined whether acknowledgements have been received from a quorum of the set of replica nodes. For example, server node(s) 110A-110N determine whether acknowledgements are received from a quorum (e.g., majority) of the set of replica server nodes (e.g., server node(s) 110A-110N). In embodiments, if it is determined that acknowledgements have been received from a quorum of the set of replica nodes, flowchart 900 proceeds to step 920, otherwise flowchart 900 proceeds to step 922. In embodiments, flowchart 900 proceeds to step 922 after the expiration of an acknowledgement timeout in order to provide sufficient time for acknowledgements to be received.

In step 920, an indication is returned to indicate the successful execution of the instruction. For example, server node(s) 110A-110N return an indication that execution of the instruction was successful via response(s) 134A-134N.

In step 922, an indication is returned to indicate the failed execution of the instruction. For example, server node(s) 110A-110N return an indication that execution of the instruction has failed via response(s) 134A-134N.

### III. Example Mobile Device and Computer System Implementation

Client 102, server infrastructure 104, network 106, application 108, server node(s) 110A-110N, data replicator(s) 120A-120N, data store(s) 122A-122N, code generator 202, data fragment(s) 204A-204D, code fragment(s) 206A-206B, code fragment(s) 208A-208B, modified code fragment 504A, modified code fragment 504C, and/or the components described therein, and/or the steps of flowcharts 300, 400, 600, 800, and/or 900 are implemented in hardware, or hardware combined with one or both of software and/or firmware. For example, client 102, server infrastructure 104, network 106, application 108, server node(s) 110A-110N, data replicator(s) 120A-120N, data store(s) 122A-122N, code generator 202, data fragment(s) 204A-204D, code fragment(s) 206A-206B, code fragment(s) 208A-208B, modified code fragment 504A, modified code fragment 504C, and/or the components described therein, and/or the steps of flowcharts 300, 400, 600, 800, and/or 900 are each implemented as computer program code/instructions configured to be executed in one or more processors and stored in a computer readable storage medium. Alternatively, client 102, server infrastructure 104, network 106, application 108, server node(s) 110A-110N, data replicator(s) 120A-120N, data store(s) 122A-122N, code generator 202, data fragment(s) 204A-204D, code fragment(s) 206A-206B, code fragment(s) 208A-208B, modified code fragment 504A, modified code fragment 504C, and/or the components described therein, and/or the steps of flowcharts 300, 400, 600, 800, and/or 900 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 10. FIG. 10 shows a block diagram of an exemplary computing environment 1000 that includes a computing device 1002. Computing device 1002 is an example of client 102, which each include one or more of the components of computing device 1002. In some embodiments, computing device 1002 is communicatively coupled with devices (not shown in FIG. 10) external to computing environment 1000 via network 1004. Network 1004 comprises one or more networks such as local area networks (LANs), wide area networks (WANs), enterprise networks, the Internet, etc. In examples, network 1004 includes one or more wired and/or wireless portions. In some examples, network 1004 additionally or alternatively includes a cellular network for cellular communications. Computing device 1002 is described in detail as follows.

Computing device 1002 can be any of a variety of types of computing devices. Examples of computing device 1002 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 1002 is a stationary computing device such as a desktop computer, a personal computer (PC), a stationary server device, a minicomputer, a mainframe, a supercomputer, etc.

As shown in FIG. 10, computing device 1002 includes a variety of hardware and software components, including a processor 1010, a storage 1020, a graphics processing unit (GPU) 1042, a neural processing unit (NPU) 1044, one or more input devices 1030, one or more output devices 1050, one or more wireless modems 1060, one or more wired interfaces 1080, a power supply 1082, a location information (LI) receiver 1084, and an accelerometer 1086. Storage 1020 includes memory 1056, which includes non-removable memory 1022 and removable memory 1024, and a storage device 1088. Storage 1020 also stores an operating system 1012, application programs 1014, and application data 1016. Wireless modem(s) 1060 include a Wi-Fi modem 1062, a Bluetooth modem 1064, and a cellular modem 1066. Output device(s) 1050 includes a speaker 1052 and a display 1054. Input device(s) 1030 includes a touch screen 1032, a microphone 1034, a camera 1036, a physical keyboard 1038, and a trackball 1040. Not all components of computing device 1002 shown in FIG. 10 are present in all embodiments, additional components not shown may be present, and in a particular embodiment any combination of the components are present. In examples, components of computing device 1002 are mounted to a circuit card (e.g., a motherboard) of computing device 1002, integrated in a housing of computing device 1002, or otherwise included in computing device 1002. The components of computing device 1002 are described as follows.

In embodiments, a single processor 1010 (e.g., central processing unit (CPU), microcontroller, a microprocessor, signal processor, ASIC (application specific integrated circuit), and/or other physical hardware processor circuit) or multiple processors 1010 are present in computing device 1002 for performing such tasks as program execution, signal coding, data processing, input/output processing, power control, and/or other functions. In examples, processor 1010 is a single-core or multi-core processor, and each processor core is single-threaded or multithreaded (to provide multiple threads of execution concurrently). Processor 1010 is configured to execute program code stored in a computer readable medium, such as program code of operating system 1012 and application programs 1014 stored in storage 1020. The program code is structured to cause processor 1010 to perform operations, including the processes/methods disclosed herein. Operating system 1012 controls the allocation and usage of the components of computing device 1002 and provides support for one or more application programs 1014 (also referred to as “applications” or “apps”). In examples, application programs 1014 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 1010 includes one or more general processors (e.g., CPUs) configured with or coupled to one or more hardware accelerators, such as one or more NPUs 1044 and/or one or more GPUs 1042.

Any component in computing device 1002 can communicate with any other component according to function, although not all connections are shown for ease of illustration. For instance, as shown in FIG. 10, bus 1006 is a multiple signal line communication medium (e.g., conductive traces in silicon, metal traces along a motherboard, wires, etc.) present to communicatively couple processor 1010 to various other components of computing device 1002, although in other embodiments, an alternative bus, further buses, and/or one or more individual signal lines is/are present to communicatively couple components. Bus 1006 represents one or more of any of several types of bus structures, including a memory bus or memory controller, a peripheral bus, an accelerated graphics port, and a processor or local bus using any of a variety of bus architectures.

Storage 1020 is physical storage that includes one or both of memory 1056 and storage device 1088, which store operating system 1012, application programs 1014, and application data 1016 according to any distribution. Non-removable memory 1022 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 1022 includes main memory and is separate from or fabricated in a same integrated circuit as processor 1010. As shown in FIG. 10, non-removable memory 1022 stores firmware 1018 that is present to provide low-level control of hardware. Examples of firmware 1018 include BIOS (Basic Input/Output System, such as on personal computers) and boot firmware (e.g., on smart phones). In examples, removable memory 1024 is inserted into a receptacle of or is otherwise coupled to computing device 1002 and can be removed by a user from computing device 1002. Removable memory 1024 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 1088 are present that are internal and/or external to a housing of computing device 1002 and are or are not removable. Examples of storage device 1088 include a hard disk drive, a SSD, a thumb drive (e.g., a USB (Universal Serial Bus) flash drive), or other physical storage device.

One or more programs are stored in storage 1020. Such programs include operating system 1012, one or more application programs 1014, and other program modules and program data. Examples of such application programs include computer program logic (e.g., computer program code/instructions) for implementing client 102, server infrastructure 104, network 106, application 108, server node(s) 110A-110N, data replicator(s) 120A-120N, data store(s) 122A-122N, code generator 202, data fragment(s) 204A-204D, code fragment(s) 206A-206B, code fragment(s) 208A-208B, modified code fragment 504A, modified code fragment 504C, and/or each of the components described therein, as well as any of flowcharts 300, 400, 600, 800, 900, and/or any individual steps thereof.

Storage 1020 also stores data used and/or generated by operating system 1012 and application programs 1014 as application data 1016. Examples of application data 1016 include web pages, text, images, tables, sound files, video data, and other data. In examples, application data 1016 is sent to and/or received from one or more network servers or other devices via one or more wired or wireless networks. Storage 1020 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 1002 through one or more input devices 1030 and receives information from computing device 1002 through one or more output devices 1050. Input device(s) 1030 includes one or more of touch screen 1032, microphone 1034, camera 1036, physical keyboard 1038 and/or trackball 1040 and output device(s) 1050 includes one or more of speaker 1052 and display 1054. Each of input device(s) 1030 and output device(s) 1050 are integral to computing device 1002 (e.g., built into a housing of computing device 1002) or are external to computing device 1002 (e.g., communicatively coupled wired or wirelessly to computing device 1002 via wired interface(s) 1080 and/or wireless modem(s) 1060). Further input devices 1030 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1054 displays information, as well as operating as touch screen 1032 by receiving user commands and/or other information (e.g., by touch, finger gestures, virtual keyboard, etc.) as a user interface. Any number of each type of input device(s) 1030 and output device(s) 1050 are present, including multiple microphones 1034, multiple cameras 1036, multiple speakers 1052, and/or multiple displays 1054.

In embodiments where GPU 1042 is present, GPU 1042 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 1042 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 1044 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 1028. In an example, NPU 1044 is configured for a data-driven parallel computing and is highly efficient at processing massive multimedia data such as videos and images and processing data for neural networks. NPU 1044 is configured for efficient handling of AI-related tasks, such as speech recognition, background blurring in video calls, photo or video editing processes like object detection, etc.

In embodiments disclosed herein that implement ML models, NPU 1044 can be utilized to execute such ML models, of which MLM 1028 is an example. For instance, where applicable, MLM 1028 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 1044 is used to train MLM 1028. To train MLM 1028, training data is that includes input features (attributes) and their corresponding output labels/target values (e.g., for supervised learning) is collected. A training algorithm is a computational procedure that is used so that MLM 1028 learns from the training data. Parameters/weights are internal settings of MLM 1028 that are adjusted during training by the training algorithm to reduce a difference between predictions by MLM 1028 and actual outcomes (e.g., output labels). In some examples, MLM 1028 is set with initial values for the parameters/weights. A loss function measures a dissimilarity between predictions by MLM 1028 and the target values, and the parameters/weights of MLM 1028 are adjusted to minimize the loss function. The parameters/weights are iteratively adjusted by an optimization technique, such as gradient descent. In this manner, MLM 1028 is generated through training by NPU 1044 to be used to generate inferences based on received input feature sets for particular applications. MLM 1028 is generated as a computer program or other type of algorithm configured to generate an output (e.g., a classification, a prediction/inference) based on received input features, and is stored in the form of a file or other data structure.

In examples, such training of MLM 1028 by NPU 1044 is supervised or unsupervised. According to supervised learning, input objects (e.g., a vector of predictor variables) and a desired output value (e.g., a human-labeled supervisory signal) train MLM 1028. The training data is processed, building a function that maps new data on expected output values. Example algorithms usable by NPU 1044 to perform supervised training of MLM 1028 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 1028 is an LLM, MLM 1028 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 1028 is trained to learn patterns from unlabeled data. For instance, in embodiments where MLM 1028 implements unsupervised learning techniques, MLM 1028 identifies one or more classifications or clusters to which an input belongs. During a training phase of MLM 1028 according to unsupervised learning, MLM 1028 tries to mimic the provided training data and uses the error in its mimicked output to correct itself (i.e., correct weights and biases). In further examples, NPU 1044 perform unsupervised training of MLM 1028 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 1044 need not necessarily be present in all ML model embodiments. In embodiments where ML models are present, any one or more of processor 1010, GPU 1042, and/or NPU 1044 can be present to train and/or execute MLM 1028.

One or more wireless modems 1060 can be coupled to antenna(s) (not shown) of computing device 1002 and can support two-way communications between processor 1010 and devices external to computing device 1002 through network 1004, as would be understood to persons skilled in the relevant art(s). Wireless modem 1060 is shown generically and can include a cellular modem 1066 for communicating with one or more cellular networks, such as a GSM network for data and voice communications within a single cellular network, between cellular networks, or between the mobile device and a public switched telephone network (PSTN). In examples, wireless modem 1060 also or alternatively includes other radio-based modem types, such as a Bluetooth modem 1064 (also referred to as a “Bluetooth device”) and/or Wi-Fi modem 1062 (also referred to as an “wireless adaptor”). Wi-Fi modem 1062 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1064 is configured to communicate with another Bluetooth-capable device according to the Bluetooth short-range wireless technology standard(s) such as IEEE 802.15.1 and/or managed by the Bluetooth Special Interest Group (SIG).

Computing device 1002 can further include power supply 1082, LI receiver 1084, accelerometer 1086, and/or one or more wired interfaces 1080. Example wired interfaces 1080 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 1080 of computing device 1002 provide for wired connections between computing device 1002 and network 1004, or between computing device 1002 and one or more devices/peripherals when such devices/peripherals are external to computing device 1002 (e.g., a pointing device, display 1054, speaker 1052, camera 1036, physical keyboard 1038, etc.). Power supply 1082 is configured to supply power to each of the components of computing device 1002 and receives power from a battery internal to computing device 1002, and/or from a power cord plugged into a power port of computing device 1002 (e.g., a USB port, an A/C power port). LI receiver 1084 is useable for location determination of computing device 1002 and in examples includes a satellite navigation receiver such as a Global Positioning System (GPS) receiver and/or includes other type of location determiner configured to determine location of computing device 1002 based on received information (e.g., using cell tower triangulation, etc.). Accelerometer 1086, when present, is configured to determine an orientation of computing device 1002.

Note that the illustrated components of computing device 1002 are not required or all-inclusive, and fewer or greater numbers of components can be present as would be recognized by one skilled in the art. In examples, computing device 1002 includes one or more of a gyroscope, barometer, proximity sensor, ambient light sensor, digital compass, etc. In an example, processor 1010 and memory 1056 are co-located in a same semiconductor device package, such as being included together in an integrated circuit chip, FPGA, or system-on-chip (SOC), optionally along with further components of computing device 1002.

In embodiments, computing device 1002 is configured to implement any of the above-described features of flowcharts herein. Computer program logic for performing any of the operations, steps, and/or functions described herein is stored in storage 1020 and executed by processor 1010.

In some embodiments, server infrastructure 1070 is present in computing environment 1000 and is communicatively coupled with computing device 1002 via network 1004. Server infrastructure 1070, when present, is a network-accessible server set (e.g., a cloud-based environment or platform). As shown in FIG. 10, server infrastructure 1070 includes clusters 1072. Each of clusters 1072 comprises a group of one or more compute nodes and/or a group of one or more storage nodes. For example, as shown in FIG. 10, cluster 1072 includes nodes 1074. Each of nodes 1074 are accessible via network 1004 (e.g., in a “cloud-based” embodiment) to build, deploy, and manage applications and services. In examples, any of nodes 1074 is a storage node that comprises a plurality of physical storage disks, SSDs, and/or other physical storage devices that are accessible via network 1004 and are configured to store data associated with the applications and services managed by nodes 1074.

Each of nodes 1074, as a compute node, comprises one or more server computers, server systems, and/or computing devices. For instance, a node 1074 in accordance with an embodiment includes one or more of the components of computing device 1002 disclosed herein. Each of nodes 1074 is configured to execute one or more software applications (or “applications”) and/or services and/or manage hardware resources (e.g., processors, memory, etc.), which are utilized by users (e.g., customers) of the network-accessible server set. In examples, as shown in FIG. 10, nodes 1074 includes a node 1046 that includes storage 1048 and/or one or more of a processor 1058 (e.g., similar to processor 1010, GPU 1042, and/or NPU 1044 of computing device 1002). Storage 1048 stores application programs 1076 and application data 1078. Processor(s) 1058 operate application programs 1076 which access and/or generate related application data 1078. In an implementation, nodes such as node 1046 of nodes 1074 operate or comprise one or more virtual machines, with each virtual machine emulating a system architecture (e.g., an operating system), in an isolated manner, upon which applications such as application programs 1076 are executed.

In embodiments, one or more of clusters 1072 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 1072 are included in a datacenter in a distributed collection of datacenters. In embodiments, exemplary computing environment 1000 comprises part of a cloud-based platform.

In an embodiment, computing device 1002 accesses application programs 1076 for execution in any manner, such as by a client application and/or a browser at computing device 1002.

In an example, for purposes of network (e.g., cloud) backup and data security, computing device 1002 additionally and/or alternatively synchronizes copies of application programs 1014 and/or application data 1016 to be stored at network-based server infrastructure 1070 as application programs 1076 and/or application data 1078. In examples, operating system 1012 and/or application programs 1014 include a file hosting service client configured to synchronize applications and/or data stored in storage 1020 at network-based server infrastructure 1070.

In some embodiments, on-premises servers 1092 are present in computing environment 1000 and are communicatively coupled with computing device 1002 via network 1004. On-premises servers 1092, when present, are hosted within an organization's infrastructure and, in many cases, physically onsite of a facility of that organization. On-premises servers 1092 are controlled, administered, and maintained by IT (Information Technology) personnel of the organization or an IT partner to the organization. Application data 1098 can be shared by on-premises servers 1092 between computing devices of the organization, including computing device 1002 (when part of an organization) through a local network of the organization, and/or through further networks accessible to the organization (including the Internet). Furthermore, in examples, on-premises servers 1092 serve applications such as application programs 1096 to the computing devices of the organization, including computing device 1002. Accordingly, in examples, on-premises servers 1092 include storage 1094 (which includes one or more physical storage devices such as storage disks and/or SSDs) for storage of application programs 1096 and application data 1098 and include a processor 1090 (e.g., similar to processor 1010, GPU 1042, and/or NPU 1044 of computing device 1002) for execution of application programs 1096. In some embodiments, multiple processors 1090 are present for execution of application programs 1096 and/or for other purposes. In further examples, computing device 1002 is configured to synchronize copies of application programs 1014 and/or application data 1016 for backup storage at on-premises servers 1092 as application programs 1096 and/or application data 1098.

Embodiments described herein may be implemented in one or more of computing device 1002, network-based server infrastructure 1070, and on-premises servers 1092. For example, in some embodiments, computing device 1002 is used to implement systems, clients, or devices, or components/subcomponents thereof, disclosed elsewhere herein. In other embodiments, a combination of computing device 1002, network-based server infrastructure 1070, and/or on-premises servers 1092 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1020. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1014) are stored in storage 1020. Such computer programs can also be received via wired interface(s) 1060 and/or wireless modem(s) 1060 over network 1004. Such computer programs, when executed or loaded by an application, enable computing device 1002 to implement features of embodiments discussed herein. Accordingly, such computer programs represent controllers of the computing device 1002.

Embodiments are also directed to computer program products comprising computer code or instructions stored on any computer-readable medium or computer-readable storage medium. Such computer program products include the physical storage of storage 1020 as well as further physical storage types.

### IV. Additional Example Embodiments

In embodiments, a method comprises: receiving first data; storing a first copy of the first data on a first node; storing, prior to satisfaction of a predetermined code generation condition, a second copy of the first data on a plurality of second nodes by storing a first data fragment of the first data and a second data fragment of the first data on different second nodes; determining that the predetermined code generation condition is satisfied; generating a code fragment based on the first data; and deleting the first copy of the first data from the first node.

In embodiments, the method further comprises: designating, prior to receiving the first data, the first node and a third node as code fragment nodes for storing code fragments; and designating, prior to receiving the first data, the plurality of second nodes as data fragment nodes for storing data fragments.

In embodiments, generating a code fragment comprises: generating, based on the first data, a plurality of code fragments comprising a first code fragment and a second code fragment; storing, on the first node, the first code fragment; and storing, on a third node, the second code fragment.

In embodiments, the predetermined code generation condition is satisfied based on at least one of: a modification frequency associated with the first data; a proportion of the first data that has been modified during a predetermined time period; a computational cost associated with generating the code fragment; or an amount of time elapsed since a previous modification of the first data.

In embodiments, the method further comprises: detecting, after generating the code fragment, an instruction that modifies the first data fragment; generating, while maintaining the first data fragment unchanged, a modified first data fragment by executing the instruction on the first data fragment; storing a first copy of the modified first data fragment on the first node; storing a second copy of the modified first data fragment on the second node of the plurality of second nodes storing the first data fragment; receiving a request for the first data fragment; and returning, as a response to the request, a copy of the modified first data fragment.

In embodiments, the method further comprises: modifying, after generating the code fragment, the second copy of the first data; determining that a predetermined code deletion condition is satisfied based on a degree of modification associated with the second copy of the first data; generating a third copy of the first data based on the modified second copy of the first data stored on the plurality of second nodes; storing the third copy of the first data; and deleting the code fragment.

In embodiments, the predetermined code deletion condition is satisfied based on at least one of: a modification frequency associated with the second copy of the first data stored on the plurality of second nodes; a proportion of the second copy of the first data that has been modified since generating the code fragment; or a computational cost associated with generating the code fragment.

In embodiments, a system comprises: a processor; and a memory device storing program code structured to cause the processor to: receive first data; store a first copy of the first data on a first node; store, prior to satisfaction of a predetermined code generation condition, a second copy of the first data on a plurality of second nodes by storing a first data fragment of the first data and a second data fragment of the first data on different second nodes; determine that the predetermined code generation condition is satisfied; generate a code fragment based on the first data; and delete the first copy of the first data from the first node.

In embodiments, the program code is further structured to cause the processor to: designate, prior to receiving the first data, the first node and a third node as code fragment nodes for storing code fragments; and designate, prior to receiving the first data, the plurality of second nodes as data fragment nodes for storing data fragments.

In embodiments, to generate a code fragment, the program code is structured to cause the processor to: generate, based on the first data, a plurality of code fragments comprising a first code fragment and a second code fragment; store, on the first node, the first code fragment; and store, on a third node, the second code fragment.

In embodiments, the predetermined code generation condition is satisfied based on at least one of: a modification frequency associated with the first data; a proportion of the first data that has been modified during a predetermined time period; a computational cost associated with generating the code fragment; or an amount of time elapsed since a previous modification of the first data.

In embodiments, the program code is further structured to cause the processor to: detect, after generating the code fragment, an instruction that modifies the first data fragment; generate, while maintaining the first data fragment unchanged, a modified first data fragment by executing the instruction on the first data fragment; store a first copy of the modified first data fragment on the first node; store a second copy of the modified first data fragment on the second node of the plurality of second nodes storing the first data fragment; receive a request for the first data fragment; and return, as a response to the request, a copy of the modified first data fragment.

In embodiments, the program code is further structured to cause the processor to: modify, after generating the code fragment, the second copy of the first data; determine that a predetermined code deletion condition is satisfied based on a degree of modification associated with the second copy of the first data; generate a third copy of the first data based on the modified second copy of the first data stored on the plurality of second nodes; store the third copy of the first data; and delete the code fragment.

In embodiments, the predetermined code deletion condition is satisfied based on at least one of: a modification frequency associated with the second copy of the first data stored on the plurality of second nodes; a proportion of the second copy of the first data that has been modified since generating the code fragment; or a computational cost associated with generating the code fragment.

In embodiments, a computer-readable storage medium comprises computer-executable instructions that, when executed by a processor, cause the processor to: designate, prior to receiving first data, a first node as a code fragment node for storing code fragments and a plurality of second nodes as data fragment nodes for storing data fragments; receive the first data; store a first copy of the first data on a third node; store, prior to satisfaction of a predetermined code generation condition, a second copy of the first data on the plurality of second nodes by storing a first data fragment of the first data and a second data fragment of the first data on different second nodes; determine that the predetermined code generation condition is satisfied; generate a first code fragment based on the first data; store the first code fragment on the first node; and delete the first copy of the first data.

In embodiments, the computer-executable instructions, when executed by the processor, further cause the processor to: generate a second code fragment based on the first data; and store the second code fragment on the third node.

In embodiments, the predetermined code generation condition is satisfied based on at least one of: a modification frequency associated with the first data; a proportion of the first data that has been modified during a predetermined time period; a computational cost associated with generating the code fragment; or an amount of time elapsed since a previous modification of the first data.

In embodiments, the computer-executable instructions, when executed by the processor, further cause the processor to: detect, after generating the code fragment, an instruction that modifies the first data fragment; generate, while maintaining the first data fragment unchanged, a modified first data fragment by executing the instruction on the first data fragment; store a first copy of the modified first data fragment on the first node; store a second copy of the modified first data fragment on the second node of the plurality of second nodes storing the first data fragment; receive a request for the first data fragment; and return, as a response to the request, a copy of the modified first data fragment.

In embodiments, the computer-executable instructions, when executed by the processor, further cause the processor to: modify, after generating the code fragment, the second copy of the first data; determine that a predetermined code deletion condition is satisfied based on a degree of modification associated with the second copy of the first data; generate a third copy of the first data based on the modified second copy of the first data stored on the plurality of second nodes; store the third copy of the first data; and delete the first code fragment.

In embodiments, the predetermined code deletion condition is satisfied based on at least one of: a modification frequency associated with the second copy of the first data stored on the plurality of second nodes; a proportion of the second copy of the first data that has been modified since generating the code fragment; or a computational cost associated with generating the code fragment.

### V. CONCLUSION

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method comprising:
receiving first data;
storing a first copy of the first data on a first node;
storing, prior to satisfaction of a predetermined code generation condition, a second copy of the first data on a plurality of second nodes by storing a first data fragment of the first data and a second data fragment of the first data on different second nodes;
determining that the predetermined code generation condition is satisfied;
generating a code fragment based on the first data; and
deleting the first copy of the first data from the first node.

2. The method of claim 1, further comprising:
designating, prior to receiving the first data, the first node and a third node as code fragment nodes for storing code fragments; and
designating, prior to receiving the first data, the plurality of second nodes as data fragment nodes for storing data fragments.

3. The method of claim 2, wherein said generating a code fragment comprises:
generating, based on the first data, a plurality of code fragments comprising a first code fragment and a second code fragment;
storing, on the first node, the first code fragment; and
storing, on a third node, the second code fragment.

4. The method of claim 1, wherein the predetermined code generation condition is satisfied based on at least one of:
a modification frequency associated with the first data;
a proportion of the first data that has been modified during a predetermined time period;
a computational cost associated with generating the code fragment; or
an amount of time elapsed since a previous modification of the first data.

5. The method of claim 1, further comprising:
detecting, after generating the code fragment, an instruction that modifies the first data fragment;
generating, while maintaining the first data fragment unchanged, a modified first data fragment by executing the instruction on the first data fragment;
storing a first copy of the modified first data fragment on the first node;
storing a second copy of the modified first data fragment on the second node of the plurality of second nodes storing the first data fragment;
receiving a request for the first data fragment; and
returning, as a response to the request, a copy of the modified first data fragment.

6. The method of claim 1, further comprising:
modifying, after generating the code fragment, the second copy of the first data;
determining that a predetermined code deletion condition is satisfied based on a degree of modification associated with the second copy of the first data;
generating a third copy of the first data based on the modified second copy of the first data stored on the plurality of second nodes;
storing the third copy of the first data; and
deleting the code fragment.

7. The method of claim 6, wherein the predetermined code deletion condition is satisfied based on at least one of:
a modification frequency associated with the second copy of the first data stored on the plurality of second nodes;
a proportion of the second copy of the first data that has been modified since generating the code fragment; or
a computational cost associated with generating the code fragment.

8. A system comprising:
a processor; and
a memory device storing program code structured to cause the processor to:
receive first data;
store a first copy of the first data on a first node;
store, prior to satisfaction of a predetermined code generation condition, a second copy of the first data on a plurality of second nodes by storing a first data fragment of the first data and a second data fragment of the first data on different second nodes;
determine that the predetermined code generation condition is satisfied;
generate a code fragment based on the first data; and
delete the first copy of the first data from the first node.

9. The system of claim 8, wherein the program code is further structured to cause the processor to:
designate, prior to receiving the first data, the first node and a third node as code fragment nodes for storing code fragments; and
designate, prior to receiving the first data, the plurality of second nodes as data fragment nodes for storing data fragments.

10. The system of claim 9, wherein, to generate a code fragment, the program code is structured to cause the processor to:
generate, based on the first data, a plurality of code fragments comprising a first code fragment and a second code fragment;
store, on the first node, the first code fragment; and
store, on a third node, the second code fragment.

11. The system of claim 8, wherein the predetermined code generation condition is satisfied based on at least one of:
a modification frequency associated with the first data;
a proportion of the first data that has been modified during a predetermined time period;
a computational cost associated with generating the code fragment; or
an amount of time elapsed since a previous modification of the first data.

12. The system of claim 8, wherein the program code is further structured to cause the processor to:
detect, after generating the code fragment, an instruction that modifies the first data fragment;
generate, while maintaining the first data fragment unchanged, a modified first data fragment by executing the instruction on the first data fragment;
store a first copy of the modified first data fragment on the first node;
store a second copy of the modified first data fragment on the second node of the plurality of second nodes storing the first data fragment;
receive a request for the first data fragment; and
return, as a response to the request, a copy of the modified first data fragment.

13. The system of claim 8, wherein the program code is further structured to cause the processor to:
modify, after generating the code fragment, the second copy of the first data;
determine that a predetermined code deletion condition is satisfied based on a degree of modification associated with the second copy of the first data;
generate a third copy of the first data based on the modified second copy of the first data stored on the plurality of second nodes;
store the third copy of the first data; and
delete the code fragment.

14. The system of claim 13, wherein the predetermined code deletion condition is satisfied based on at least one of:
a modification frequency associated with the second copy of the first data stored on the plurality of second nodes;
a proportion of the second copy of the first data that has been modified since generating the code fragment; or
a computational cost associated with generating the code fragment.

15. A computer-readable storage medium comprising computer-executable instructions that, when executed by a processor, cause the processor to:
designate, prior to receiving first data, a first node as a code fragment node for storing code fragments and a plurality of second nodes as data fragment nodes for storing data fragments;
receive the first data;
store a first copy of the first data on a third node;
store, prior to satisfaction of a predetermined code generation condition, a second copy of the first data on the plurality of second nodes by storing a first data fragment of the first data and a second data fragment of the first data on different second nodes;
determine that the predetermined code generation condition is satisfied;
generate a first code fragment based on the first data;
store the first code fragment on the first node; and
delete the first copy of the first data.

16. The computer-readable storage medium of claim 15, wherein the computer-executable instructions, when executed by the processor, further cause the processor to:
generate a second code fragment based on the first data; and
store the second code fragment on the third node.

17. The computer-readable storage medium of claim 15, wherein the predetermined code generation condition is satisfied based on at least one of:
a modification frequency associated with the first data;
a proportion of the first data that has been modified during a predetermined time period;
a computational cost associated with generating the code fragment; or
an amount of time elapsed since a previous modification of the first data.

18. The computer-readable storage medium of claim 15, wherein the computer-executable instructions, when executed by the processor, further cause the processor to:
detect, after generating the code fragment, an instruction that modifies the first data fragment;
generate, while maintaining the first data fragment unchanged, a modified first data fragment by executing the instruction on the first data fragment;
store a first copy of the modified first data fragment on the first node;
store a second copy of the modified first data fragment on the second node of the plurality of second nodes storing the first data fragment;
receive a request for the first data fragment; and
return, as a response to the request, a copy of the modified first data fragment.

19. The computer-readable storage medium of claim 15, wherein the computer-executable instructions, when executed by the processor, further cause the processor to:
modify, after generating the code fragment, the second copy of the first data;
determine that a predetermined code deletion condition is satisfied based on a degree of modification associated with the second copy of the first data;
generate a third copy of the first data based on the modified second copy of the first data stored on the plurality of second nodes;
store the third copy of the first data; and
delete the first code fragment.

20. The computer-readable storage medium of claim 19, wherein the predetermined code deletion condition is satisfied based on at least one of:
a modification frequency associated with the second copy of the first data stored on the plurality of second nodes;
a proportion of the second copy of the first data that has been modified since generating the code fragment; or
a computational cost associated with generating the code fragment.
